(19) United States
(12) Patent Application Publication
(10) Pub. No.: US 2026/0267390 A1
(43) Pub. Date: Sep. 10, 2026

(54) CACHE MAINTENANCE REQUESTS

(71) Applicant: Arm Limited, Cambridge (GB)

(72) Inventors: Vincent RISSON, Antibes (FR); Stefano GHIGGINI, Antibes (FR); Albin Pierrick TONNERRE, Nice (FR); Krishna Kumar NATARAJAN, Austin, TX (US)

(21) Appl. No.: 19/074,664

(22) Filed: Mar. 10, 2025

(51) Int. Cl. G06F 1/3206

(52) U.S. Cl. CPC G06F 1/3206

(57) ABSTRACT

An apparatus comprises a power domain comprising a cache, wherein the power domain is configured to transition between power states, at least one of the power states being a power-saving state; receiving circuitry configured to receive, from an external agent, cache maintenance requests targeting the cache, in which: while the power domain is in the power-saving state, the receiving circuitry is configured to: buffer, in request buffer circuitry configured to operate outside of the power domain, one or more cache maintenance requests targeting the cache of the power domain, and return, before the power domain is caused to transition out of the power-saving state, an indication to the external agent that the one or more cache maintenance requests are guaranteed to be completed.

### BACKGROUND

### Technical Field

The present technique relates to the field of data processing systems. In particular, the present technique relates to cache maintenance requests.

### Technical Background

A data processing apparatus may be capable of transitioning between several power states, with some power states restricting the data processing apparatus from performing certain tasks, e.g. due to the requisite circuitry being powered down, in order to save power. When those tasks are not being performed, the energy consumption of the data processing apparatus may be reduced by transitioning between power states.

A data processing apparatus may also be provided with a cache for temporarily storing data that has recently been fetched from memory. A data processing apparatus may support transmitting and/or receiving messages requesting maintenance of cached data, e.g. to request invalidation of out of date cached data for which the underlying data in memory has been updated by software.

### SUMMARY

At least some examples of the present technique provide an apparatus comprising: a power domain comprising a cache, wherein the power domain is configured to transition between power states, at least one of the power states being a power-saving state; receiving circuitry configured to receive, from an external agent, cache maintenance requests targeting the cache, in which: while the power domain is in the power-saving state, the receiving circuitry is configured to: buffer, in request buffer circuitry configured to operate outside of the power domain, one or more cache maintenance requests targeting the cache of the power domain, and return, before the power domain is caused to transition out of the power-saving state, an indication to the external agent that the one or more cache maintenance requests are guaranteed to be completed.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide a method comprising: transitioning a power domain between power states, at least one of the power states being a power-saving state, wherein the power domain comprises a cache; receiving, from an external agent, cache maintenance requests targeting the cache, in which: while the power domain is in the power-saving state: buffering, in request buffer circuitry configured to operate outside of the power domain, one or more cache maintenance requests targeting the cache of the power domain, and returning, before the power domain is caused to transition out of the power-saving state, an indication to the external agent that the one or more cache maintenance requests are guaranteed to be completed.

At least some examples of the present technique provide a non-transitory computer-readable medium storing computer-readable code for fabrication of an apparatus comprising: a power domain comprising a cache, wherein the power domain is configured to transition between power states, at least one of the power states being a power-saving state; receiving circuitry configured to receive, from an external agent, cache maintenance requests targeting the cache, in which: while the power domain is in the power-saving state, the receiving circuitry is configured to: buffer, in request buffer circuitry configured to operate outside of the power domain, one or more cache maintenance requests targeting the cache of the power domain, and return, before the power domain is caused to transition out of the power-saving state, an indication to the external agent that the one or more cache maintenance requests are guaranteed to be completed.

Further aspects, features and advantages of the present technique will be apparent from the following description of examples, which is to be read in conjunction with the accompanying drawings.

### BRIEF DESCRIPTION OF THE DRAWINGS

FIG. 1 illustrates a data processing system comprising a data processing apparatus;

FIG. 2 illustrates an apparatus comprising a power domain;

FIGS. 3A and 3B illustrate examples of sequences of steps for buffering cache maintenance requests while the power domain is in a power-saving state;

FIG. 4 illustrates a sequence of steps for transitioning out of the power-saving state;

FIG. 5 illustrates a sequence of steps for a requesting device that sends a cache maintenance request;

FIG. 6 illustrates a system and a chip-containing product.

### DESCRIPTION OF EXAMPLES

In some examples, an apparatus comprises a power domain which is configured to transition between power states, at least one of the power states being a power-saving state. The power domain in these examples comprises as least a cache. When the power domain is in the power-saving state some of the functionality associated with the cache (e.g. lookups, reads, writes, etc.) may be temporarily disabled, which allows the apparatus to reduce power consumption when access to the cache is not needed. The cache may be targeted by a cache maintenance request by an external agent that may be outside of the power domain or in a different power domain. For example, the cache maintenance request may comprise a request to update cache status metadata associated with an entry corresponding to a particular address, e.g. to invalidate the entry or change its coherency status. Since these cache maintenance requests are received from an external agent, they may be received regardless of which power state the power domain is currently in. In particular, they may be received while the power domain is in the power-saving state and hence unable to service the cache maintenance requests.

One approach could be to transition the power domain out of the power-saving state and into a powered up state when a cache maintenance request is received so that the cache maintenance request can then be performed. While this may allow the cache maintenance request to be serviced sooner, it incurs a power cost in transitioning a power domain out of the power-saving state when it would not otherwise have needed to exit the power-saving state.

In the apparatus according to the present techniques, there is provided receiving circuitry configured to receive the cache maintenance requests that target the cache. While the power domain is in the power-saving state, the receiving circuitry is configured to buffer, in request buffer circuitry configured to operate outside of the power domain, one or more cache maintenance requests targeting the cache of the power domain, and return, before the power domain is caused to transition out of the power-saving state, an indication to the external agent that the cache maintenance request is guaranteed to be completed. Hence, by providing the request buffer circuitry outside of the power domain, the request buffer circuitry can track any received cache maintenance requests without the power domain being required to transition out of the power-saving state (e.g. into a powered up state), thereby avoiding the associated increase in energy consumption. A guarantee that the cache maintenance request will be completed can be sufficient to unblock the external agent from proceeding with a corresponding action, so it is not essential for the cache maintenance request to actually be serviced before the response indication is sent to the external agent. By avoiding waiting for the cache maintenance request to actually be serviced before returning the indication to the external agent, the external agent can be unblocked faster.

In some examples, data stored in the cache is retained while the power domain is in the power-saving state. Therefore, data that may be targeted by a cache maintenance request would be retained while the power domain is in the power-saving state, which means the cache maintenance request should be serviced eventually, even if not right away (in contrast, for power-saving states which do not provide cached data retention, it would be sufficient to simply ignore the cache maintenance request as the data would be lost on power down anyway). Hence, the provision of the request buffer circuitry enables placing a cache (which is subject to external cache maintenance requests) in a power domain supporting a power-saving state which provides data retention, without incurring the power cost of waking the power domain up each time an external cache maintenance request is received.

In some examples, the receiving circuitry and the request buffer circuitry are configured to operate in a powered state at least while the power domain is in the power-saving state. Accordingly, there is at least some functionality for receiving cache maintenance requests when the power domain is in the power-saving state. In some examples, the request buffer circuitry may power down if the power domain is in a different power state where the cache is capable of handling cache maintenance requests directly (i.e. without buffering in the request buffer circuitry—in that case the receiving circuitry may also be powered down), or if the power domain is in a power-off state which does not guarantee retention of data in the cache (for which it may be safe for the receiving circuitry to simply return the indication of a guarantee of completion and drop the incoming cache maintenance request without servicing the request, as the corresponding data in the cache is lost anyway). In other examples, the receiving circuitry and request buffer circuitry may be kept in an always-on power state.

In some examples, the receiving circuitry is responsive to the power domain transitioning out of the power-saving state, to forward the one or more cache maintenance requests to be performed by the cache. The power domain may transition out of the power-saving state for various reasons, such as a power-on trigger or resumption of data processing that requires access to data in the cache. Once the power domain has transitioned out of the power-saving state, limitations on the functionality of the cache may be removed or reduced such that the one or more cache maintenance requests can be performed.

In some examples, the apparatus comprises request control circuitry configured to stall at least one data processing operation from being performed in the power domain until the one or more cache maintenance requests have been performed. Such a data processing operation may rely on data which is targeted by the cache maintenance request, which presents a data hazard due to the use of potentially stale data. Accordingly, the request control circuitry stalls that data processing operation to prevent it from using the data until the cache maintenance request has been performed. In various examples, the request control circuitry may cause the stall at different levels of precision. For example, the request control circuitry may identify a particular data processing operation that requests the use of cached data that is targeted by an uncompleted cache maintenance request, and then specifically stall that data processing operation (and any operations dependent on that data processing operation), such that other data processing operations independent of the stalled data processing operation may continue. In another example, the request control circuitry may stall data processing operations even if they do not use cached data targeted by an uncompleted cache maintenance request. It will be appreciated that, since some latency may be incurred when warming up after transitioning out of a power-saving state, the added latency of stalling more data processing operations may be comparatively small, such that stalling those data processing operations is acceptable compared to implementing more complex logic for tracking and comparing operands of pending cache maintenance requests and data processing operations to identify whether the data processing operations target the same cache entries as the cache maintenance requests.

In some examples, the at least one data processing operation comprises a memory access operation. The memory access operation may cause an access to the cache, e.g. to load or use the potentially stale data, so is one such operation that may present a hazard, and hence may be stalled by the request control circuitry.

Nevertheless, other non-memory access operations may also be stalled even if they do not themselves present a hazard, since it may be simpler to implement a generic stall mechanism which stalls operations regardless of operation type, rather than checking for specific operation types when deciding whether to stall.

In some examples, the capacity of the request buffer circuitry may not be sufficient to buffer every cache maintenance request received while the power domain is in the power-saving state. In some examples, the receiving circuitry is configured to cause the power domain to transition out of the power-saving state in response to a number of cache maintenance requests in the request buffer circuitry reaching a predetermined threshold (where the predetermined threshold is greater than one). In such examples, by causing the power domain to transition out of the power-saving state, e.g. and into a powered up state, some or all of the pending cache maintenance requests may be performed. The power up transition caused by the buffer becoming full will occur later than the equivalent power up transition that would have been needed if the request buffer circuitry had not been provided at all, so in comparison to an implementation not providing the request buffer circuitry at all, a power saving can be made, but eventually once the available buffer capacity runs out (or is close to running out, depending on the chosen threshold), the power up transition can be triggered.

In other examples, in particular those in which the one or more cache maintenance requests comprise invalidation requests, it may be considered more valuable to keep the power domain in the power-saving state (i.e. without the receiving circuitry causing a transition out of the power-saving state), and to instead over-invalidate the cache when the power domain does eventually power up. Accordingly, the receiving circuitry may be responsive to a number of cache maintenance requests in the request buffer circuitry reaching a predetermined threshold to cause all data stored in the cache to be invalidated after the power domain transitions from the power-saving state. Invalidating the entire cache may be performed more quickly than performing a large number of more fine-grained invalidations individually, which may require multiple lookups to identify each target cache line for invalidation. Accordingly, where the number of cache maintenance requests are sufficiently large, the trade-off of quicker invalidation may justify also invalidating entries which are potentially still valid.

In either of the above examples, the receiving circuitry may determine that the number of cache maintenance requests in the request buffer circuitry has reached the predetermined threshold in response to an overflow in the request buffer circuitry. For example, the overflow can be detected when a counter tracking occupancy overflows (e.g. a predetermined bit of the counter switches state).

In some examples, the request buffer circuitry is configured to record, for a given cache maintenance request, at least one invalidation condition identifier identifying one or more invalidation conditions which when satisfied by a given entry in the cache indicates that the given entry is to be invalidated during performance of the given cache maintenance request. Accordingly, when the cache maintenance requests are to be performed (e.g. after the power domain transitions out of the power-saving state), the invalidation condition identifiers can be made available for identifying the entries in the cache for invalidation.

In some examples, the request buffer circuitry may record only some (i.e. not all) of the invalidation condition(s) specified by a given cache maintenance request, depending on the level of precision required by the request buffer circuitry. For example, identifying fewer invalidation conditions allows for smaller entries for each of the cache maintenance requests in the request buffer circuitry. Accordingly, the request buffer circuitry may be made smaller for a given number of cache maintenance requests, thus reducing circuit area.

One example of an invalidation condition comprises a condition satisfied by the given entry when the given entry is associated with a virtual machine identifier or an address space identifier specified by the given cache maintenance request. Another example of an invalidation condition comprises a condition satisfied by the given entry when the given entry is associated with a memory address corresponding to a memory address or memory address range specified by the given cache maintenance request. Such examples of invalidation conditions may be implemented separately or in combination with each other or other invalidation conditions that may be specified by the given cache maintenance request.

In some examples, the cache comprises an address translation cache configured to store address translation data based on translation table structures obtained from memory. One example of such an address translation cache is a translation lookaside buffer (TLB). The address translation data may comprise mappings between a virtual address and a physical address, between a virtual address and an intermediate physical address, or between an intermediate physical address and a physical address. It will be appreciated that if the translation table structures in memory are modified, e.g. by an operating system running on an external agent, then address translation data held in the address translation cache may be targeted by a cache maintenance request to invalidate those address translations (i.e. a TLB invalidation request).

In some examples, the cache comprises an instruction cache configured to store data processing instructions. The instruction cache may be in close association with an instruction fetch unit and an instruction decoder so that instructions can be efficiently supplied for execution of a program. Similar to the above, an instruction cache may be targeted by cache maintenance requests, e.g. where dynamic code generation causes a modification to instructions that have already been prefetched into the cache.

The techniques discussed above are particularly useful for a TLB or instruction cache, as these are example for which the cache cannot typically hold “dirty” data which differs from the data held in underlying memory (in contrast, a data cache used to service load/store operations can have its data modified to be dirty relative to memory). For a cache which can hold dirty data, it is likely that the cache is subject to snoop requests when other requesters need to access corresponding data, which would require waking up the cache if it is currently in the power saving state with data retention. Therefore, as such snoop requests are expected to be relatively frequent, the benefit of providing the retention power-saving state is lower. In contrast, for a “read only” style cache (such as a TLB or instruction cache), which is only expected to be read to obtain faster access to data held in underlying memory but is not expected to have its cached data modified relative to the underlying copy in memory), the retention power-saving state can be beneficial and there is no need for the cache to be snooped while in retention power-saving state. The provision of the request buffer circuitry helps avoid the need to wake up the power domain comprising the cache solely for servicing cache maintenance requests.

In some examples, the power domain further comprises processing circuitry configured to access the cache for executing data processing instructions. In such examples, the processing circuitry and the cache being in the same power domain means that they would both be in the power-saving state at the same time. In such examples, the indication that the one or more cache maintenance requests are guaranteed to be completed can provide further confidence that stale data will not be used, because the processing circuitry will also be limited from performing some functionality, e.g. executing data processing instructions, while the power domain is in the power-saving state.

Specific examples are now described with reference to the drawings.

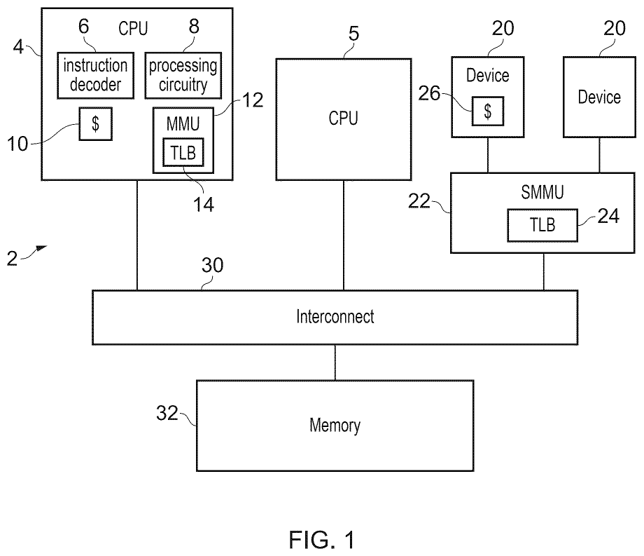

FIG. 1 schematically illustrates an example of an apparatus (e.g. a data processing system, integrated circuit or system on chip) 2 having at least two processors 4, 5. In this example each processor 4, 5 is a CPU (Central Processing Unit), but either or both of the processors 4, 5 can be replaced by other examples of processors such as a GPU (Graphics Processing Unit) or NPU (Neural Processing Unit—a type of processor with specialized hardware for accelerating vector and/or matrix operations or other operations used in Neural Network and other machine learning processing). FIG. 1 illustrates the internal arrangement of only one processor 4 for conciseness. It will nonetheless be appreciated that the other processor 5 may include the same internal arrangement as will be described below or may include a different arrangement. The processor 4 has an instruction decoder 6 for decoding program instructions and processing circuitry 8 which is controlled to perform processing operations in response to the instructions decoded by the instruction decoder 6. The processor 4 has a cache 10 for caching data from memory for faster access by the processor, and may be configured for various types of data such as program data, instructions or both. The processor 4 has a memory management unit (MMU) 12 which functions as address translation circuitry for translating virtual addresses specified by instructions executed by the processor 4 into physical addresses identifying locations within the memory system. The MMU may have at least one TLB 14 for storing translation entries which depend on page table data from page table structures stored in the memory system. The page table structures define the address mappings between virtual and physical addresses and may also define memory access permissions which may define whether certain software processes executing on the processor 4 are allowed to access certain addresses. The MMU 12 may support 2-stage address translation where the mapping of a virtual address to a physical address depends on both stage 1 address translation data which maps the virtual address (VA) to an intermediate physical address (IPA) and stage 2 translation data which maps the IPA to a physical address (PA). The stage 1 address translation data may be set by an operating system or virtual machine. The stage 2 translation data may be set by a hypervisor.

The processors 4, 5 are examples of requester devices which are capable of executing program instructions. While FIG. 1 only shows two such requester devices, it will be appreciated that system 2 could have three or more such devices, which may include further CPUs or could include other types of instruction execution devices such as a graphics processing unit (GPU). In addition to the processors 4, 5 or other devices capable of instruction execution which have their own internal MMU 12, the system may also include requester devices 20 which may not have an internal MMU, and so for accessing memory and providing address translation functionality, such devices may communicate with the rest of the system 2 via a system memory management unit (SMMU) 22 which includes address translation circuitry which controls address translation and memory permissions based on translation data defined in page table structures in memory. Again, the SMMU 22 may have one or more TLBs 24 which have a similar functionality to the TLBs 14 within the MMU 12 of the processor 4. The devices 20 which access memory via the SMMU 22 can include cached devices which include an internal cache 26 and uncached devices which do not have any cache. For example, a device 20 could include a display controller for controlling display of image frames on display, a network controller for controlling input or output of data via a network, a hardware accelerator for performing certain dedicated processing functions in a more efficient manner than can be achieved using software executing on a generic processor such as the processor 4, and so on.

All of the requester devices 4, 5, 20 communicate with each other via an interconnect 30 which is responsible for routing transactions between the requester devices and memory 32. Interconnect 30 may also be responsible for maintaining consistency of data cached in respective caches 10, 14, 24, 26 of the system through the use of cache maintenance requests generated by a requester device or, in some examples, by a home node connected to the interconnect. For example, for data caches 10, 26, the interconnect 30 may operate a coherency protocol to provide hardware-managed coherency between the private caches 10, 26 of particular requester devices and underlying data in memory. For the TLBs 14, 24, coherency may be managed in software, such that when software is modifying translation table structures in memory, once the modification is complete software will request that the interconnect issues one or more cache maintenance requests (e.g. TLB invalidation requests) requesting invalidation of any TLB entries in TLBs 14, 24 which meet a set of invalidation criteria.

Each of the requester devices 4, 5, 20 may be associated with different power domains which may be in different power states during various stages of operation. For example, the processor 4 may be in one power domain that is in a power-saving state, whereas the requester devices 20 or the other processor 5 may be in a different power domain that is in a powered up state. Hence, in the present description, any of the requester devices and/or a home node may be considered an “external agent” from the perspective of each other requester device that is in a different power domain. For example, from the perspective of the processor 4 in one power domain, the other processor 5 and the devices 20 may each be considered an “external agent” outside of that power domain. It will also be appreciated that the external agent, from which the cache maintenance request is received, may not be the device that originally initiated the cache maintenance request. For example, any of the devices 4, 5, 20 may have caused a cache maintenance request to be generated or forwarded by a home node on behalf of that requester device to any other device (including to the same device that originally initiated the cache maintenance request). It will be appreciated that FIG. 1 is a simplified diagram and the system 2 may have many other components not shown in FIG. 1 for conciseness.

The caches 10, 14, 24, 26 may also retain cached data, even when their respective power domains transition between power states. For example, if one of the processors 4 is in the power-saving state, the caches 10, 14 may still retain data that could be targeted by a cache maintenance request generated by a requester device 20 or the other processor 4 in the system 2.

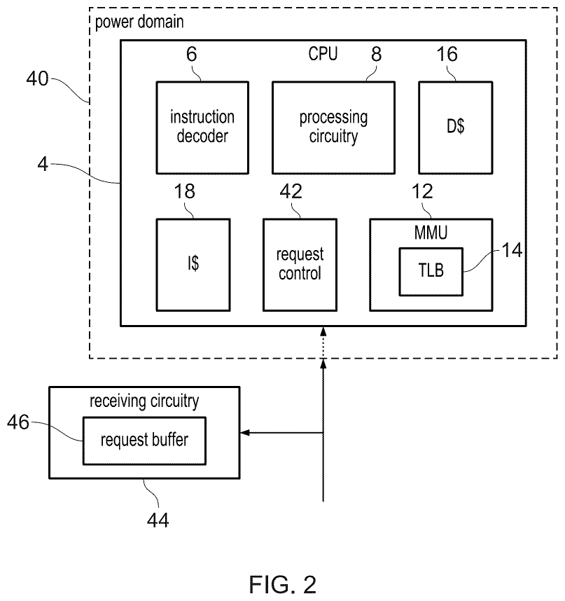

FIG. 2 illustrates an example of an interface between the processor 4 and the interconnect 30. FIG. 2 illustrates a separate data cache 16 and instruction cache 18. The instruction cache 18 may be coupled with a fetch stage (not illustrated) which sequentially fetches instructions from the instruction cache 18 under the control of, e.g. a program counter. The processor 4 in this example is shown as entirely within one power domain 40 for ease of illustration, however it will be appreciated that, in other examples, some components of the processor 4 may be split among two or more power domains. For example, the instruction decoder 6 and the processing circuitry 8 may be in a different power domain to the data cache 16 (e.g. such that the data cache 16 may be kept powered on to service incoming snoop requests even while the processing circuitry 8 is in a power-saving state). A cache maintenance request received from the interconnect 30 may target any of the data cache 16, instruction cache 18 or the TLB 14 for requesting maintenance of data, instructions and address translations respectively. It will be appreciated that the specific mechanism of a cache maintenance request may vary depending on which of the caches 14, 16, 18 is being targeted. For example, requests targeting the TLB 14 may be TLB invalidation commands initiated by an operating system while modifying the translation tables in memory 32, whereas requests targeting the data cache 16 may be snoop requests initiated by the interconnect 30 in response to memory access requests issued by another requester agent of a shared memory system. In some examples, the present techniques may be applied only to cache maintenance requests that target read-only caches (which hold copies of data obtained from memory, but cannot hold dirty data which is modified relative to the underlying data in memory), such as the TLB 14 and the instruction cache 18, and not to cache maintenance requests that target read-and-write caches, such as the data cache 16 (which support writing of data held in the cache to make the data dirty, so as to be different to the underlying copy held in memory).

For example, if the other processor 5 in the system 2 modifies a data value, an instruction or address translation in a translation table in memory, then cache maintenance requests of an appropriate type (e.g. TLB invalidation command, snoop request, etc.) may be routed through the interconnect 30 to request invalidation or other maintenance of the metadata associated with any existing cached data. In this example, the processor 4 is also provided with request control circuitry 42 which may control the handling of such cache maintenance requests.

As discussed above, cache maintenance requests may be received while the power domain 40 is in a power-saving state, such that the cache maintenance request would not be capable of being performed due some capabilities of the processor 4 being deactivated or otherwise unavailable while in the power-saving state. According to the present techniques, there is provided receiving circuitry 44 which maintains a request buffer 46 for buffering one or more cache maintenance requests that are targeting a cache in the power domain 40. As shown in FIG. 2, the request buffer 46 is provided outside of the power domain 40, thereby allowing the request buffer 46 to operate in a power state independently of the power state of the power domain 40. In some examples, the request buffer 46 may be operated in a powered state at least while the power domain 40 is in the power-saving state, but otherwise may be powered off since the processor 4 may otherwise be capable of receiving and handing any incoming cache maintenance requests directly. In examples where cached data is lost (i.e. or not guaranteed to be retained) when entering the power-saving state, the request buffer 46 may also be powered off since the data that might be targeted by a received cache maintenance request is no longer in the cache. In further examples, the receiving circuitry 44 and request buffer 46 could even be kept in an always-on power state.

Accordingly, if a cache maintenance request is received from the interconnect 30 while the power domain 40 is in a power-saving state, the cache maintenance request is buffered in the request buffer 46. Prior to the power domain 40 being caused to transition out of the power-saving state, the receiving circuitry is configured to return an indication that the cache maintenance request is guaranteed to be completed. That indication may be routed, by the interconnect 30, back to the source of the cache maintenance request to indicate that the cache maintenance request has been acknowledged and will be performed. Some protocols that may be supported by the interconnect 30 allow cache maintenance requests to be acknowledged in batches for reduced traffic. In such implementations, the receiving circuitry may return the guarantee indication after a plurality of cache maintenance requests have been received (e.g. with the guarantee being returned in response to a synchronisation request received from the external agent that requests a response guaranteeing that any cache maintenance requests received prior to the synchronisation request are guaranteed to be completed), instead of returning a guarantee indication after every individual cache maintenance request.

Accordingly, if any other process is dependent on the cache maintenance request being completed (e.g. due to a hazard), returning a guarantee indication allows such a process to continue as though the cache maintenance request has been completed. In examples where the request buffer 46 is powered-off (e.g. due to cached data not being retained in the power-saving state), the receiving circuitry may still return the guarantee indications, even though the cache maintenance requests do not need to be buffered or performed.

Since the cache maintenance request is buffered, the power domain 40 is not required to transition out of the power-saving state to handle the cache maintenance request. Hence, the power domain 40 may stay in the power-saving state for longer, thereby preventing an increase in power consumption. It will be appreciated that a request buffer 46 with a larger capacity would be capable of buffering more cache maintenance requests, thereby preventing an increasing in power consumption for longer. When the power domain 40 transitions out of the power-saving state for another reason, e.g. to continue data processing, the receiving circuitry can forward any buffered cache maintenance requests to be performed by the target cache of the caches 14, 16, 18. Accordingly, the guarantee that had previously been returned to the source of the cache maintenance request is upheld and data coherency is maintained.

While the example of FIG. 2 illustrates the interface between the processor 4 and the interconnect 30, it will be appreciated that the receiving circuitry 44 and the request buffer 46 may also be provided at the interface between the SMMU 22 and the interconnect 30, or at the interface between the SMMU 22 and the cached requester device 20. Accordingly, cache maintenance requests targeting the TLB 24 or the cache 26 may also be buffered if a respective power domain of those devices are in a power-saving state, thereby allowing those power domains to remain in a power-saving state for longer as described above.

It will be appreciated that a given cache maintenance request may comprise various information to enable the cache maintenance request to be performed. For example, where a cache maintenance request is an invalidation request, the request may include at least one invalidation condition identifier for identifying one or more invalidation conditions which, if satisfied by a given entry in the target cache, indicates that the given entry is to be invalidated. Examples of invalidation conditions may include the given entry matching a specified virtual machine identifier (VMID), address space identifier (ASID), memory address and/or memory address range specified by the given cache maintenance request.

For effective management of the available capacity in the request buffer 46, different examples may record the indicated invalidation conditions in the request buffer 46 at differing levels of detail. In some examples, all of the one or more invalidation conditions may be recorded in the request buffer 46 so that the cache maintenance requests are performed based on the conditions specified in the request. In other examples, to reduce the size of each entry, only some (i.e. not all) of the one or more invalidation conditions may be recorded in the request buffer 46. For example, the VMID or ASID may be recorded in the request buffer 46 without any specific memory address or address range for identifying a target entry. This allows a smaller request buffer 46 to be implemented for a given number of cache maintenance requests because less data is recorded for each cache maintenance request, but also risks over-invalidating the caches 14, 16, 18 when the cache maintenance requests are performed. In particular, instead of invalidating only the data that was originally targeted by the cache maintenance request, other entries (including potentially still valid entries) associated with the VMID or ASID are invalidated. Some implementations of the present techniques therefore may consider a trade-off of reducing the size of each entry in the request buffer 46, while incurring some performance loss of unnecessarily invalidating valid entries (i.e. which may cause those entries to have to be fetched from memory 32 again).

In some scenarios, cache maintenance requests may be sufficiently numerous that it becomes impractical to continue to buffer all of them due to a limited capacity of the request buffer 46. While one solution could be to simply increase the capacity of the request buffer 46 to accommodate more entries, this comes at a hardware cost of increased circuit area and power consumption. Accordingly, in some examples, the receiving circuitry 44 may track a number of cache maintenance requests that are being tracked in the request buffer 46 to determine when it reaches a predetermined threshold and performs an action in response.

In some examples, the receiving circuitry 44 may be provided with the capability to trigger the power domain 40 to transition between power states. In particular, the receiving circuitry 44 may be responsive to the number of cache maintenance requests tracked in the request buffer 46 reaching the predetermined threshold to cause the power domain 40 to transition out of the power-saving state so that the cache maintenance requests can be performed.

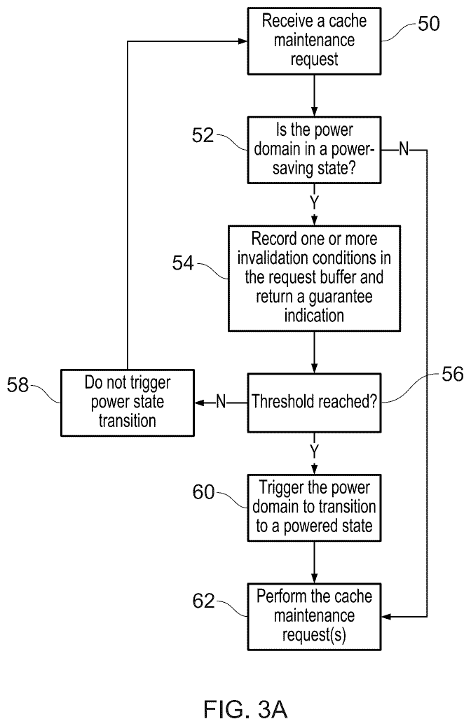

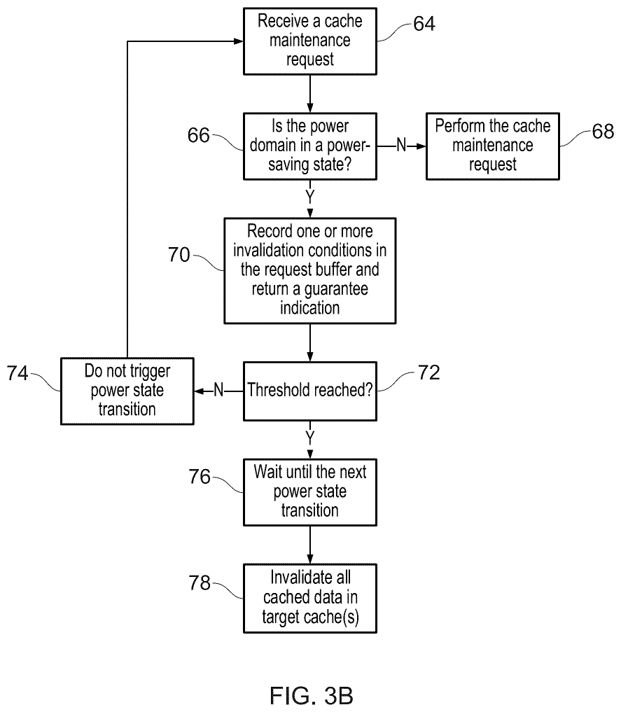

FIG. 3A illustrates a sequence of steps for such an example. The process begins at step 50, by receiving a cache maintenance request, e.g. from the interconnect 30. At step 52, it is determined whether the power domain 40 is in a power-saving state. If not (e.g. the power domain is in a powered up state), then the cache maintenance request may be performed right away at step 62. If the power domain 40 is in the power-saving state, then at step 54, one or more invalidation conditions are recorded in the request buffer 46 and an indication that the cache maintenance request is guaranteed to be performed is returned. It will be appreciated that, while in this example, the cache maintenance request comprises an invalidation request specifying one or more invalidation conditions as described previously, other types of cache maintenance requests (e.g. to update the value or other metadata of a target entry) may also be recorded in the request buffer 46.

At step 56, it is determined whether the predetermined threshold has been reached after recording the latest cache maintenance request. If not, then at step 58, a power state transition is not triggered, and the receiving circuitry 44 may await a next cache maintenance request at step 50. If the predetermined threshold has been reached, then at step 60, the receiving circuitry 44 triggers the power domain 40 to transition to a powered state. In doing so, the target cache 14, 16, 18 may regain the functionality to perform cache maintenance requests (e.g. due to such functionality being unavailable while in the power-saving state). Accordingly, at step 62, the cache maintenance requests may be performed.

According to this example, the request buffer 46 may be filled up to the threshold, at which point it may be determined that the cache maintenance requests are sufficiently numerous that they should be performed sooner. Accordingly, such examples provide a balance between keeping the power domain 40 in the power-saving state (thereby preventing an increase in power consumption) and managing the available capacity of the request buffer 46.

The predetermined threshold may be set to control how soon the receiving circuitry 44 should trigger the power domain 40 to transition into a powered state. In some examples, the predetermined threshold can be set lower to cause a transition to a powered state before the request buffer 46 is completely full. Alternatively, the predetermined threshold can be set higher to keep the power domain 40 in the power-saving state for longer. In some examples, the receiving circuitry 44 may detect that the predetermined threshold has been reached due to an overflow occurring in the request buffer 46 (i.e. indicating that the request buffer 46 has reached or exceeded its maximum capacity).

In another example, the receiving circuitry 44 may not trigger the power domain 40 to transition to a powered state upon reaching the predetermined threshold. Instead, it can be determined that the cache maintenance requests that can fit in the buffer 46 are sufficiently numerous, that the performance loss of over-invalidation (i.e. not only invalidating the entries targeted by the cache maintenance requests, but also invalidating other, potentially still valid entries) is reduced. In such examples, the receiving circuitry 44 waits until the power domain 40 transitions out of the power-saving state, and then causes the cache 14, 16, 18 to invalidate all cached data.

FIG. 3B illustrates a sequence of steps for such an example. The process begins at step 64, by receiving a cache maintenance request, e.g. from the interconnect 30, which may be directed to a particular target cache. At step 66, it is determined whether the power domain 40 is in a power-saving state. If not, then the cache maintenance request may be performed right away at step 68. If the power domain 40 is in the power-saving state, then at step 70, one or more invalidation conditions are recorded in the request buffer 46 and an indication that the cache maintenance request is guaranteed to be performed is returned.

At step 72, it is determined whether the predetermined threshold has been reached after recording the latest cache maintenance request. If not, then at step 74, a power state transition is not triggered, and the receiving circuitry 44 may await a next cache maintenance request at step 64. If the predetermined threshold has been reached, then at step 76, the receiving circuitry 44 waits until the next power state transition. During this time, any further cache maintenance requests may be buffered by overwriting previously buffered cache maintenance requests, or not buffered at all. However, the indication that the cache maintenance request is guaranteed to be performed is still returned. When the power domain 40 transitions out of the power-saving state, all cached data is invalidated in one or more caches that had been the target of at least one received cache maintenance request, at step 78.

According to this example, the request buffer 46 being filled up to the threshold is taken as an indication that a sufficient amount of the cached data is likely to be invalidated such that any performance loss of over-invalidation is preferable to the increased power consumption of causing the power domain 40 to transition out of the power-saving state early.

It will be appreciated that the cached data that is targeted by the cache maintenance requests should not be used before the cache maintenance requests have been performed. In particular, between the receipt and performance of the cache maintenance requests, there is a risk of data incoherency in the caches 14, 16, 18. Accordingly, for some examples, the request control circuitry 42 is provided to stall the processing pipeline (i.e. the fetch stage, the instruction decoder 6 and/or the processing circuitry 8) until the pending cache maintenance requests have been performed. The request control circuitry 42 may be configured to specifically stall any one or more processing pipeline stages that are configured to access or use the cached data that may be targeted by a cache maintenance request. For example, this includes the fetch stage (i.e. loading potentially stale instructions from the instruction cache 18 using memory addresses that were translated using potentially stale address translations from the TLB 14) and a load/store unit of the processing circuitry 8 for executing load/store instructions (i.e. which may access potentially stale data from the data cache 16 or accessing memory, either of which risk using potentially stale address translations from the TLB 14). Therefore, as the power domain 40 is caused to transition out of the power-saving state to perform data processing operations, the receiving circuitry 44 forwards any pending cache maintenance requests to be performed, as described above. If, for example, the processing circuitry 8 attempts to perform a memory access operation, e.g. to access data in the cache 16 or to access memory, either of which may be based on an address translation in the TLB 14, the request control circuitry 42 is configured to stall the processing circuitry 8 until the cache maintenance requests have been performed. It will be appreciated that the request control circuitry 42 may not necessarily monitor for memory access operations, and may instead stall any pending data processing operation until the cache maintenance requests have been performed. Accordingly, cached data that had become out-of-date while the power domain 40 was in the power-saving state is prevented from being used.

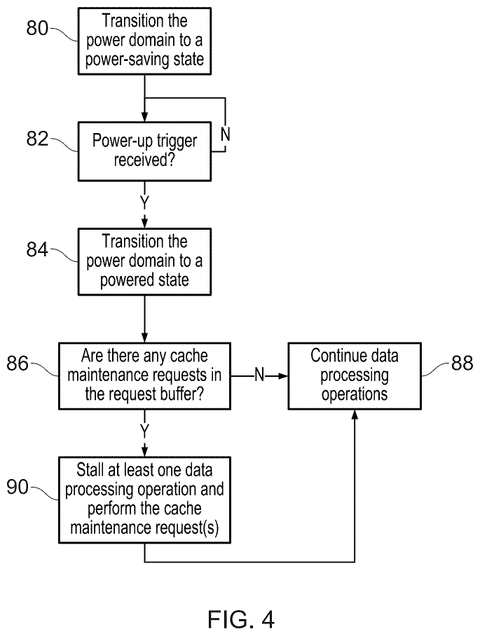

FIG. 4 illustrates a sequence of steps for operating the processing pipeline after the power domain 40 transitions out of the power-saving state. The process begins at step 80, in which the power domain 40 transitions into the power-saving state, e.g. due to a long period of idling between performing data processing operations. At step 82, the process waits until a power-up trigger is received. A power-up trigger may be received in a variety of ways, including from an indication that the processor 4 is required to perform more data processing operations, or from the receiving circuitry 44 as described in step 60 of FIG. 3A. It will be appreciated that during this time, other devices may continue data processing which may result in cache maintenance requests being received from the interconnect 30 and buffered as described in previous examples.

Upon receiving a power-up trigger, the power domain 40 transitions to a powered state at step 84. At step 86, it is determined whether there are any cache maintenance requests that have been buffered in the request buffer 46 while in the power-saving state. If not, then at step 88, the processing pipeline continues performing data processing operations. If there are cache maintenance requests in the request buffer 46, the request control circuitry 42 stalls at least one processing operation from being performed by the processing pipeline. For example, if the processing circuitry 8 attempts to perform a memory access operation, the operation is stalled. While the at least one data processing operation is stalled, the cache maintenance requests are being performed. Once they are finished, the request control circuitry 42 stops stalling the data processing operation and data processing continues in step 88.

As described above, when the receiving circuitry 44 receives a cache maintenance request, it is configured to return an indication that the cache maintenance request is guaranteed to be completed. It will be appreciated that it is not essential to acknowledge every cache maintenance request individually. As described above, some interconnect protocols may allow for acknowledging (i.e. with the guarantee indication) a plurality of cache maintenance requests in batches. The acknowledgement guarantee may be useful for whichever external agent (e.g. the requester devices 20 or the processor 5) had sent the cache maintenance request so that it may determine that any data hazard has been or will be resolved. Any data processing operations that are dependent on such a data hazard being resolved may then proceed. Accordingly, although the cache maintenance requests are buffered in the present techniques (and hence not necessarily immediately performed), returning an indication that the cache maintenance requests are guaranteed permits the other devices to continue as though the cache maintenance requests had been immediately performed. Therefore, the overall performance of the system 2 may be improved.

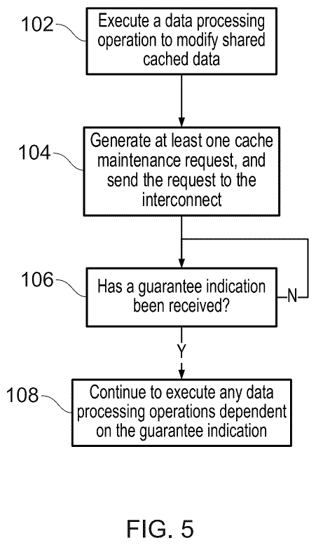

FIG. 5 illustrates a sequence of steps for an external agent. At step 102, the external agent executes a data processing operation to modify cached data that is indicated as shared by the associated coherency metadata. The indication that the cached data is shared means that it is possible for copies of the same data to be locally cached in other devices. Therefore, at step 104, at least one cache maintenance request is generated, for example to request invalidation of any locally cached copies of the data, and is sent to the interconnect 30. As mentioned in previous examples, the cache maintenance request may specify at least one invalidation condition identifier to identify one or more invalidation conditions. Therefore, the cache maintenance request generated in step 104 may specify a VMID or ASID of the process that modified the data, or a memory address/memory address range of the modified data. Such information can be used by other devices to identify local copies of the cached data that is now out-of-date and invalidate them.

At step 106, it is determined whether a guarantee indication has been received. During this time, one or more data processing operations may be prevented from being executed due to a possible hazard. Such operations may be identified as being dependent on a guarantee indication (e.g. by use of barrier instructions, etc). If a guarantee indication is received, then those data processing instructions that are dependent on the guarantee indication are permitted to proceed in step 108. It will be appreciated that there may be other data processing operations that are not dependent on the guarantee indication and which may continue to be executed while waiting for the guarantee indication in step 106.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

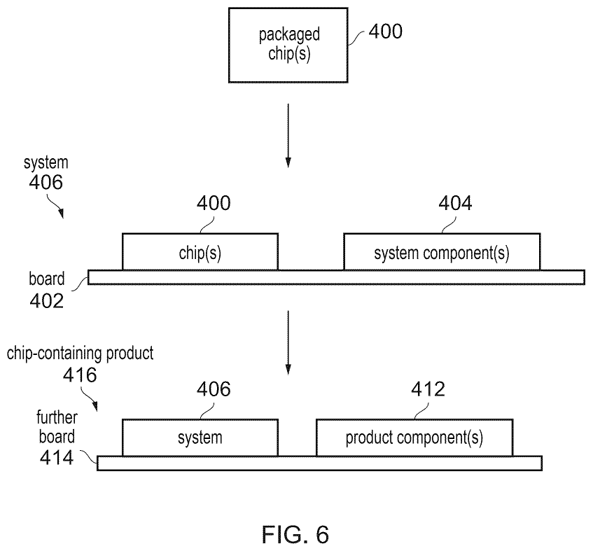

As shown in FIG. 6, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Some examples are set out in the following clauses:

(1) An apparatus comprising:
a power domain comprising a cache, wherein the power domain is configured to transition between power states, at least one of the power states being a power-saving state;
receiving circuitry configured to receive, from an external agent, cache maintenance requests targeting the cache, in which:
while the power domain is in the power-saving state, the receiving circuitry is configured to:
   buffer, in request buffer circuitry configured to operate outside of the power domain, one or more cache maintenance requests targeting the cache of the power domain, and
   return, before the power domain is caused to transition out of the power-saving state, an indication to the external agent that the one or more cache maintenance requests are guaranteed to be completed.

(2) The apparatus of clause (1), wherein data stored in the cache is retained while the power domain is in the power-saving state.

(3) The apparatus of clause (1) or clause (2), wherein the receiving circuitry and request buffer circuitry are configured to operate in a powered state at least while the power domain is in the power-saving state.

(4) The apparatus of any of clauses (1) to (3), wherein the receiving circuitry is responsive to the power domain transitioning out of the power-saving state, to forward the one or more cache maintenance requests to be performed by the cache.

(5) The apparatus of clause (4), comprising request control circuitry configured to stall at least one data processing operation from being performed in the power domain until the one or more cache maintenance requests have been performed.

(6) The apparatus of clause (5), wherein the at least one data processing operation comprises a memory access operation.

(7) The apparatus of any preceding clause, wherein the receiving circuitry is configured to cause the power domain to transition out of the power-saving state in response to a number of cache maintenance requests in the request buffer circuitry reaching a predetermined threshold.

(8) The apparatus of any of clauses (1) to (3), wherein
the one or more cache maintenance requests comprise invalidation requests; and
the receiving circuitry is responsive to a number of cache maintenance requests in the request buffer circuitry reaching a predetermined threshold to cause all data stored in the cache to be invalidated after the power domain transitions from the power-saving state.

(9) The apparatus of clause (7) or clause (8), wherein the receiving circuitry is configured to determine that the number of cache maintenance requests in the request buffer circuitry has reached the predetermined threshold in response to an overflow in the request buffer circuitry.

(10) The apparatus of any preceding clause, wherein the request buffer circuitry is configured to record, for a given cache maintenance request, at least one invalidation condition identifier identifying one or more invalidation conditions which when satisfied by a given entry in the cache indicates that the given entry is to be invalidated during performance of the given cache maintenance request.

(11) The apparatus of clause (10), wherein the one or more invalidation conditions comprises a condition satisfied by the given entry when the given entry is associated with a virtual machine identifier or an address space identifier specified by the given cache maintenance request.

(12) The apparatus of clause (10) or (11), wherein the one or more invalidation conditions comprises a condition satisfied by the given entry when the given entry is associated with a memory address corresponding to a memory address or memory address range specified by the given cache maintenance request.

(13) The apparatus of any preceding clause, wherein the cache is an address translation cache configured to store address translation data based on translation table structures obtained from memory.

(14) The apparatus of any of clauses (1) to (12), wherein the cache comprises an instruction cache configured to store data processing instructions.

(15) The apparatus of any preceding clause, wherein the power domain further comprises processing circuitry configured to access the cache for executing data processing instructions.

(16) A system comprising:
the apparatus of any preceding clause, implemented in at least one packaged chip;
at least one system component; and
a board,
wherein the at least one packaged chip and the at least one system component are assembled on the board.

(17) A chip-containing product comprising the system of clause (16), wherein the system is assembled on a further board with at least one other product component.

(18) A method comprising:
transitioning a power domain between power states, at least one of the power states being a power-saving state, wherein the power domain comprises a cache;
receiving, from an external agent, cache maintenance requests targeting the cache, in which:
while the power domain is in the power-saving state:
   buffering, in request buffer circuitry configured to operate outside of the power domain, one or more cache maintenance requests targeting the cache of the power domain, and
   returning, before the power domain is caused to transition out of the power-saving state, an indication to the external agent that the one or more cache maintenance requests are guaranteed to be completed.

(19) A non-transitory computer-readable medium storing computer-readable code for fabrication of an apparatus comprising:
a power domain comprising a cache, wherein the power domain is configured to transition between power states, at least one of the power states being a power-saving state;
receiving circuitry configured to receive, from an external agent, cache maintenance requests targeting the cache, in which:
while the power domain is in the power-saving state, the receiving circuitry is configured to:
   buffer, in request buffer circuitry configured to operate outside of the power domain, one or more cache maintenance requests targeting the cache of the power domain, and
   return, before the power domain is caused to transition out of the power-saving state, an indication to the external agent that the one or more cache maintenance requests are guaranteed to be completed.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
a power domain comprising a cache, wherein the power domain is configured to transition between power states, at least one of the power states being a power-saving state;
receiving circuitry configured to receive, from an external agent, cache maintenance requests targeting the cache, in which:
while the power domain is in the power-saving state, the receiving circuitry is configured to:
buffer, in request buffer circuitry configured to operate outside of the power domain, one or more cache maintenance requests targeting the cache of the power domain, and
return, before the power domain is caused to transition out of the power-saving state, an indication to the external agent that the one or more cache maintenance requests are guaranteed to be completed.

2. The apparatus of claim 1, wherein data stored in the cache is retained while the power domain is in the power-saving state.

3. The apparatus of claim 1, wherein the receiving circuitry and request buffer circuitry are configured to operate in a powered state at least while the power domain is in the power-saving state.

4. The apparatus of claim 1, wherein the receiving circuitry is responsive to the power domain transitioning out of the power-saving state, to forward the one or more cache maintenance requests to be performed by the cache.

5. The apparatus of claim 4, comprising request control circuitry configured to stall at least one data processing operation from being performed in the power domain until the one or more cache maintenance requests have been performed.

6. The apparatus of claim 5, wherein the at least one data processing operation comprises a memory access operation.

7. The apparatus of claim 1, wherein the receiving circuitry is configured to cause the power domain to transition out of the power-saving state in response to a number of cache maintenance requests in the request buffer circuitry reaching a predetermined threshold.

8. The apparatus of claim 7, wherein the receiving circuitry is configured to determine that the number of cache maintenance requests in the request buffer circuitry has reached the predetermined threshold in response to an overflow in the request buffer circuitry.

9. The apparatus of claim 1, wherein
the one or more cache maintenance requests comprise invalidation requests; and
the receiving circuitry is responsive to a number of cache maintenance requests in the request buffer circuitry reaching a predetermined threshold to cause all data stored in the cache to be invalidated after the power domain transitions from the power-saving state.

10. The apparatus of claim 9, wherein the receiving circuitry is configured to determine that the number of cache maintenance requests in the request buffer circuitry has reached the predetermined threshold in response to an overflow in the request buffer circuitry.

11. The apparatus of claim 1, wherein the request buffer circuitry is configured to record, for a given cache maintenance request, at least one invalidation condition identifier identifying one or more invalidation conditions which when satisfied by a given entry in the cache indicates that the given entry is to be invalidated during performance of the given cache maintenance request.

12. The apparatus of claim 11, wherein the one or more invalidation conditions comprises a condition satisfied by the given entry when the given entry is associated with a virtual machine identifier or an address space identifier specified by the given cache maintenance request.

13. The apparatus of claim 11, wherein the one or more invalidation conditions comprises a condition satisfied by the given entry when the given entry is associated with a memory address corresponding to a memory address or memory address range specified by the given cache maintenance request.

14. The apparatus of claim 1, wherein the cache is an address translation cache configured to store address translation data based on translation table structures obtained from memory.

15. The apparatus of claim 1, wherein the cache comprises an instruction cache configured to store data processing instructions.

16. The apparatus of claim 1, wherein the power domain further comprises processing circuitry configured to access the cache for executing data processing instructions.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
transitioning a power domain between power states, at least one of the power states being a power-saving state, wherein the power domain comprises a cache;
receiving, from an external agent, cache maintenance requests targeting the cache, in which:
while the power domain is in the power-saving state:
buffering, in request buffer circuitry configured to operate outside of the power domain, one or more cache maintenance requests targeting the cache of the power domain, and
returning, before the power domain is caused to transition out of the power-saving state, an indication to the external agent that the one or more cache maintenance requests are guaranteed to be completed.

20. A non-transitory computer-readable medium storing computer-readable code for fabrication of an apparatus comprising:
a power domain comprising a cache, wherein the power domain is configured to transition between power states, at least one of the power states being a power-saving state;
receiving circuitry configured to receive, from an external agent, cache maintenance requests targeting the cache, in which:
while the power domain is in the power-saving state, the receiving circuitry is configured to:
buffer, in request buffer circuitry configured to operate outside of the power domain, one or more cache maintenance requests targeting the cache of the power domain, and
return, before the power domain is caused to transition out of the power-saving state, an indication to the external agent that the one or more cache maintenance requests are guaranteed to be completed.
